(19) United States
(12) Patent Application Publication
(10) Pub. No.: US 2008/0109988 A1
(43) Pub. Date: May 15, 2008

(54) Door stop retainer assembly

(76) Inventor: Hugh Jameson, El Paso, TX (US)

Correspondence Address: Kevin W. Guynn;Greer, Burns & Crain, Ltd., Suite 2500, 300 S. Wacker Drive, Chicago, IL, 60606, US

(21) Appl. No.: 11/595,715

(22) Filed: Nov. 10, 2006

(51) Int. Cl. E05F 5/02

(52) U.S. Cl. 16/82

(57) ABSTRACT

A door stop retainer assembly includes a post member having a body arranged to be secured to one of a door and a surface adjacent the door at a proximal end thereof and extending away from the one of the door and the surface to a distal end, with the distal end having a width greater than a width of an intermediate portion, and a catch member, arranged to be secured to the other of the door and the surface adjacent the door having a substantially solid surface with at least one slit formed therein for receiving the distal end of the post member.

### BACKGROUND OF THE INVENTION

The present invention generally relates to hardware useful in arresting the opening movement of doors and unintentional closing of open doors.

Door stops are well known devices which are used to prevent doors from opening too far, such that the door might otherwise engage a wall or other surrounding feature, since damage could occur if the door handle or other portion of the door were to come into contact with such adjacent wall or surrounding feature. Some door stops are mounted on the door's hinges, some are mounted on the wall or floor at a position to be engaged when the door is moved into an open position, and some are attached directly to the door.

There are known door stop devices for catching and holding a post-type door stop which usually require the close mating of an opening sized to be closely engaged by the post, thus requiring close tolerances for the manufactured parts and precise placement and mounting of the door stop post and the post catching member.

A need exists for a door stop retainer that will allow the door stop to function properly, and to releasably hold the door in an open position without requiring close tolerances for the door stop post member or for the catch member.

### SUMMARY OF THE INVENTION

The present invention provides a door stop retainer assembly comprising a post member having a body arranged to be secured to one of a door and a surface adjacent the door at a proximal end thereof and extending away from the one of the door and the surface to a distal end, with the distal end having a width greater than a width of an intermediate portion, and a catch member, arranged to be secured to the other of the door and the surface adjacent the door having a substantially solid surface with at least one slit formed therein for receiving the distal end of the post member.

In an embodiment, the post member may be rigid or flexible and straight along its length or bent along its length.

In an embodiment, the post member distal end may flare outwardly in a direction away from the proximal end or the distal end may be bulbous.

In an embodiment, the catch member may comprise a hollow hemispherical shape.

In an embodiment, the catch member may include an adhesive layer or a threaded fastener for attaching the catch member to one of the door and the surface.

In an embodiment, the catch member comprises a plurality of slits in the substantially solid surface.

In an embodiment, the door stop retainer assembly comprises a post member arranged to be secured to one of a door and a surface adjacent the door at a proximal end thereof, a catch member secured to the other of the door and the surface adjacent the door, the post member having an elongated body and a width of the body varying along a length thereof between the proximal end, an intermediate portion and a distal end, with the width being greater at an enlarged portion than at the intermediate portion, the enlarged portion being positioned at the distal end, and the catch member having a substantially solid surface with at least one slit formed therein for receiving the post member.

In an embodiment, the door stop retainer assembly comprises a post member having a body arranged to be secured to one of a door and a surface adjacent the door at a proximal end thereof and extending away from the one of the door and the surface to a distal end, with the distal end having a width greater than a width of an intermediate portion, and a catch member, arranged to be secured to the other of the door and the surface adjacent the door, comprising a hollow hemispherical shape formed by a substantially solid wall made of an elastic and resilient material, at least one slit formed in the wall for receiving the distal end of the post member and an attachment member for securing the catch member to the other of the door and the surface.

Other details of embodiments of the present invention are illustrated in the drawings and described below.

### BRIEF DESCRIPTION OF THE DRAWINGS

FIG. 1 illustrates a perspective elevational view of an embodiment of a doorstop retainer assembly embodying the principles of the present invention.

FIG. 2 illustrates a perspective elevational view of another embodiment of a doorstop retainer assembly embodying the principles of the present invention.

FIG. 3 illustrates a perspective elevational view of another embodiment of a doorstop retainer catch member embodying the principles of the present invention.

FIG. 4 illustrates a side elevational view of a distal end portion of the post member of the retainer assembly embodying the principles of the present invention.

FIG. 5 illustrates a side elevational view of the distal end portion of FIG. 4 separated from the post member.

FIG. 6 illustrates a perspective elevational view of the embodiment of the doorstop retainer catch member of FIG. 3 and the post member of FIG. 7 in a captured position.

FIG. 7 illustrates a perspective elevational view of an embodiment of a doorstop retainer post member embodying the principles of the present invention.

FIG. 8 illustrates a perspective elevational view of another embodiment of a doorstop retainer post member embodying the principles of the present invention.

FIG. 9 illustrates a perspective elevational view of another embodiment of a doorstop retainer post member embodying the principles of the present invention.

### DETAILED DESCRIPTION OF THE PREFERRED EMBODIMENTS

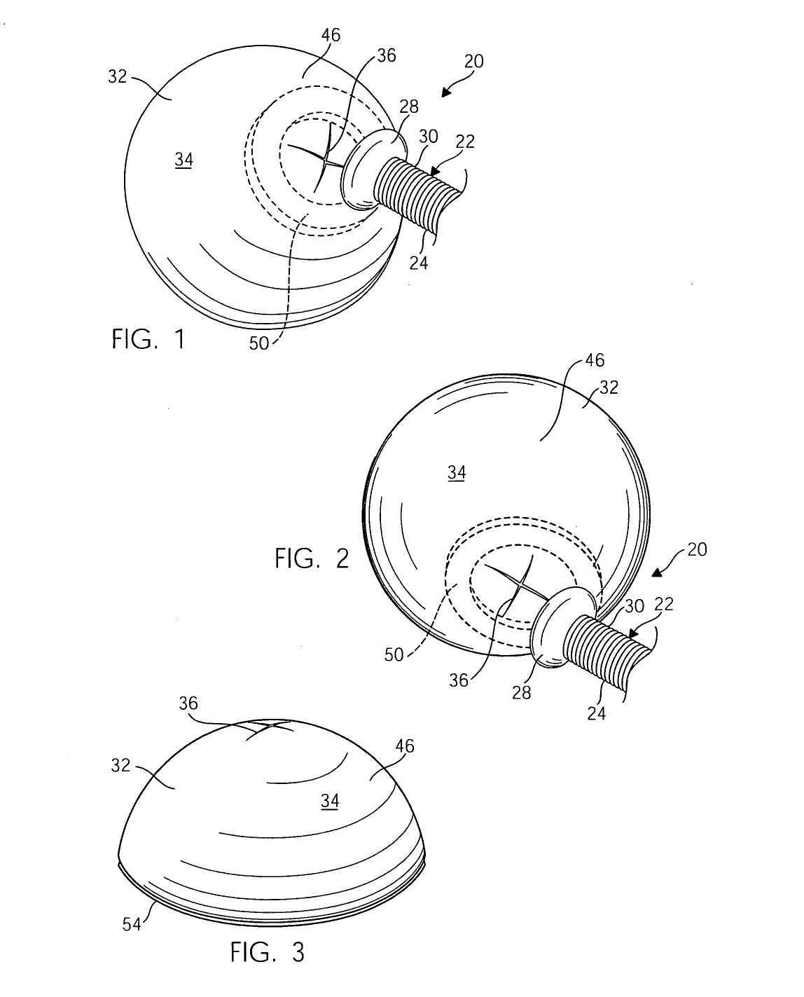

As illustrated in FIG. 1, the present invention provides a door stop retainer assembly 20 comprising a post member 22 having a body 24 arranged to be secured to one of a door and a surface adjacent the door at a proximal end 26 thereof and extending away from the one of the door and the surface to a distal end 28. The post member 22, when secured to the door, may be positioned either high or low on the door, and when on a surface adjacent the door, may be applied to a wall, baseboard, or the floor, approximately where a free edge of the door will be positioned when the door is open. The body 24 also includes an intermediate portion 30 having a reduced width.

The assembly 20 also includes a catch member 32, arranged to be secured to the other of the door and the surface adjacent the door having a substantially solid surface 34 with at least one slit 36 formed in the surface for receiving the post member 22. The catch member 32, when secured to the door, may be positioned either high or low on the door, and when on a surface adjacent the door, may be applied to a wall, baseboard, or the floor, approximately where a free edge of the door will be positioned when the door is open. The post member 22 and the catch member 32 are to be positioned so as to engage each other when the door is opened.

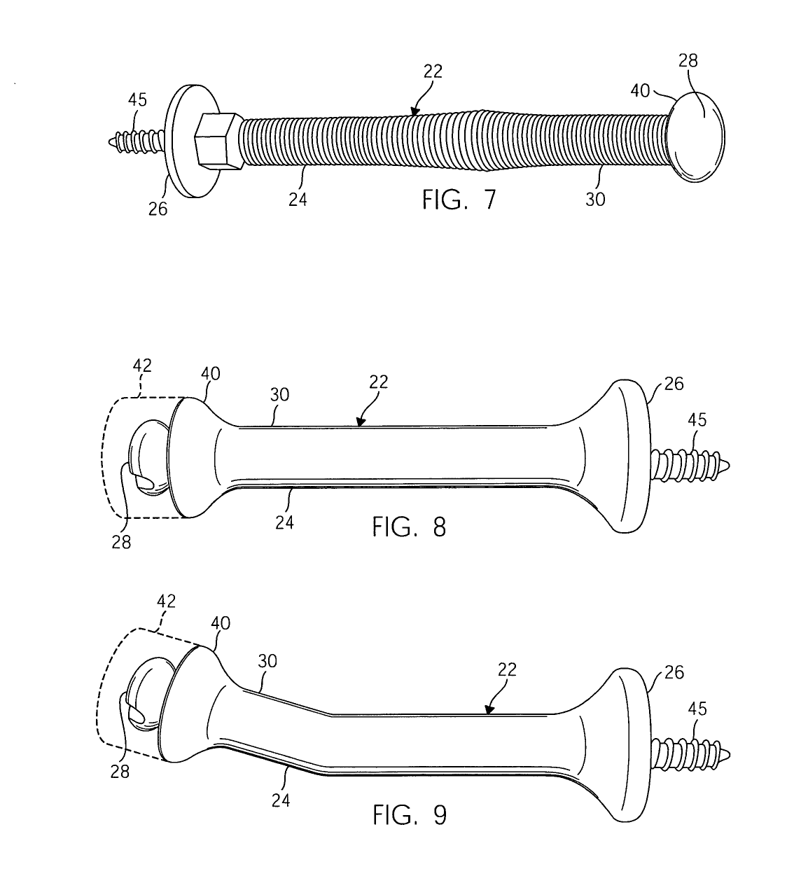

In an embodiment, the post member 22 may be rigid, particularly as illustrated in FIG. 8, or flexible, such as the embodiment illustrated in FIGS. 6 and 7. The outer surface of the post member 22 may be smooth or ribbed. The post member 22 may also be straight along its length as shown in FIG. 7 or 8 or it may be bent along its length as shown in FIG. 9. These various configurations may be dependent on the particular geometry and arrangement of the door and adjacent surface.

In an embodiment, the post member distal end 28 may flare outwardly in a direction away from the proximal end as illustrated in FIGS. 1, 2, 4, 5 and 8 or the distal end may be bulbous as illustrated in FIGS. 7 and 10. In an embodiment, the post member body 24 is elongated and a width of the body varies along a length thereof between the proximal end 26, the intermediate portion 30 and the distal end 28. The width of the body 24 may be greater at an enlarged portion 40 than at the intermediate portion 30, with the enlarged portion being positioned between the intermediate portion and the distal end 28 or at the distal end. In an embodiment, the intermediate portion 30 may have a reduced width as compared to the distal end 28 or a portion of the body 24 between the intermediate portion and the distal end. The distal end 28 may be provided with a rubber or other elastomeric bumper 42 which might be held on the outside of a tip of the post member 22 (as in FIG. 8) or received in a hollow distal end 28 of the post member. The distal end 28 may also comprise the bulbous enlarged portion 40 shown in FIG. 7, which may be hollow to frictionally receive the ribbed post 22, as shown in FIG. 10.

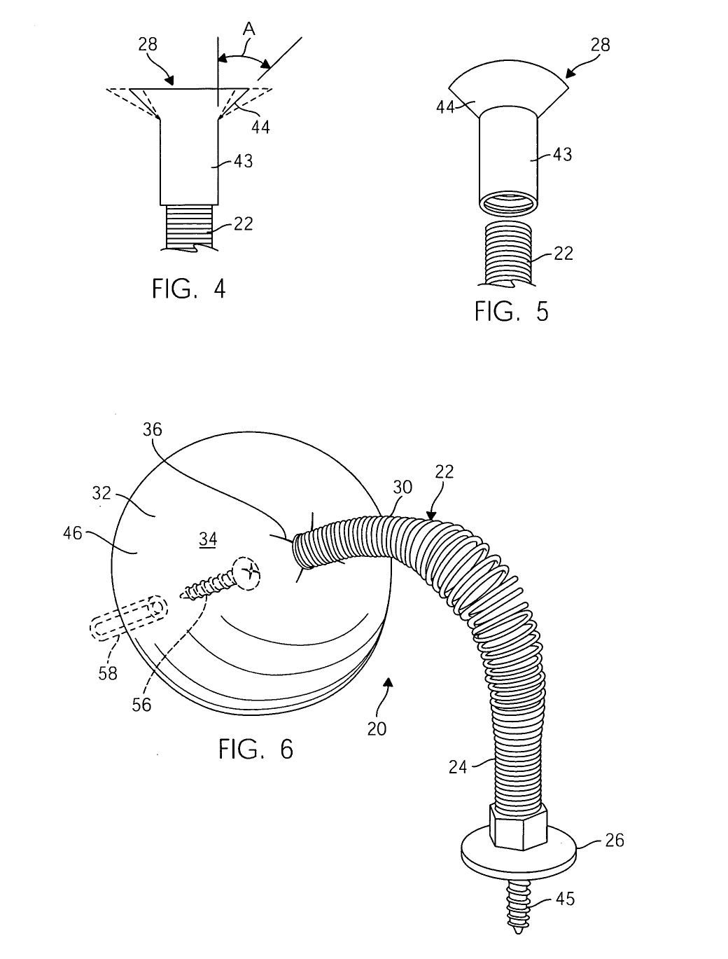

The distal end 28 may be formed of a separate end member 43, such as illustrated in FIGS. 1, 2, 4 and 5. As best seen in FIGS. 4 and 5, the end member 43 may have a sidewall 44 formed at an angle A between 30° (shown in phantom) and 60° (shown in phantom), and preferably about 45° (shown in solid lines). The greater the angle A, the greater the force will be that is required to separate the post member 22 from the catch member 32. The end member 43 may attach to the post member 22, such as by a threaded attachment, or a friction or interference fit.

A threaded fastener element 45 may be provided at the proximal end 26 to allow the post member 22 to be secured to the one of the door or the surface. Other arrangements for securing the post member 22, such as adhesives, may be provided.

The catch member 32 may comprise a hollow hemispherical shape as shown in FIGS. 1-3 and 6 or it may comprise other shapes as well. The substantially solid surface 34 may be made of an elastic and resilient material, such as a rubber or a pliant plastic material. If the catch member 32 is in the form of a hollow hemispherical shape, the surface 34 may be formed by a substantially solid wall 46 that is elastic and resilient such that the at least one slit 36 formed in the wall allows the passage of the post member 22 therethrough and the portions of the wall defined by the slit will press against the post member, even if the size of the post member varies, such as along its length, or even if the position of the post member is not centered exactly along the slit. The slit 36 may be provided in a centered position on the catch member 32, such as illustrated in FIGS. 1-3 and 6, or the slit may be provided in an off-centered position, such as shown in FIG. 2, in the event that the post member 22 engages the surface 34 at an angle due to the required placement of the catch member on the surface adjacent to the door. The catch member 32 preferably includes a hard plastic base 47 that is molded integrally with the solid surface 34 or is adhesively secured, or attached in other known manners, such as by spin welding.

When referring to the surface 34 or wall 46 as being substantially solid, what is meant is that no enlarged opening, beyond the extent of the slit 36, is made in the surface or wall to receive the post member 22. The slit 36 preferably is formed by a slicing of the material of the surface 34 or wall 46 without the removal of any material of the surface or wall. In this manner, when the post member 22 is not engaged with the catch member 32, the surface 34 or wall 46 has a generally solid, unbroken appearance, with the visibility of the slit 36 being minimal.

The catch member 32 may be provided with a relatively rigid ring 50 surrounding the slit 36, such as shown in FIGS. 1 and 2, to prevent enlargement of the slit over time, or to enhance the gripping force of the wall 46 of the catch member. The ring 50 may be formed within the material of the catch member 32, such as by embedding the ring in the material of the catch member as it is being formed. The ring 50 may also be formed on the inside surface of the catch member 32, such that the function of the ring will be provided, without the ring being visible from an exterior of the catch member.

The slit 36 may be a single slit, or a plurality of slits may be provided in the substantially solid surface 34, such as intersecting slits as shown in FIGS. 1-3 and 6. Several parallel slits may be provided, with or without an intersecting slit. The advantage of providing at least one slit 36 is that the position of the post member 22 and the catch member 32 need not be arranged with a great deal of precision since the slit will allow the surface 34 or wall 46 to open to receive the post member, even if the post member does not exactly align with the slit. Further, the use of a slit 36 will provide an opening that is self closing and will retainingly engage the post member 22, without requiring a close tolerance fit between a portion of the post member and the opening.

In an embodiment, the catch member 32 may include an adhesive layer 54 (FIG. 3) or a threaded fastener 56 (FIG. 6) extending through the base 47 of the catch member for attaching the catch member to the one of the door and the surface. When a threaded fastener 56 is used, an anchor element 58 may also be provided in the event that the wall that the catch member 32 is being attached to requires the use of the anchor element to securely retain the threaded fastener. The threaded fastener 56 may be inserted into the catch member 32, and driven, such as by a screw driver, both through the slit 36 in the catch member.

Various components and features are shown and described in different embodiments of the invention, and it should be understood that these various components and features may be used not only in the particular combinations shown and described, but also in other variations of combinations without departing from the spirit of the present invention.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A door stop retainer assembly comprising:
a post member having a body arranged to be secured to one of a door and a surface adjacent the door at a proximal end thereof and extending away from the one of the door and the surface to a distal end, with said distal end having a greater width that a width of an intermediate portion of said post member; and
a catch member, arranged to be secured to the other of the door and the surface adjacent the door having a substantially solid surface with at least one slit formed therein for receiving said distal end of said post member.

2. A door stop retainer assembly according to claim 1, wherein said post member is rigid.

3. A door stop retainer assembly according to claim 1, wherein said post member is flexible.

4. A door stop retainer assembly according to claim 1, wherein said post member is generally straight along its length.

5. A door stop retainer assembly according to claim 1, wherein said post member is bent along its length.

6. A door stop retainer assembly according to claim 1, wherein said distal end flares outwardly in a direction away from said proximal end.

7. A door stop retainer assembly according to claim 1, wherein said distal end is bulbous.

8. A door stop retainer assembly according to claim 1, wherein said catch member comprises a hollow hemispherical shape.

9. A door stop retainer assembly according to claim 1, wherein said catch member includes an adhesive layer for attaching said catch member to the other of the door and said surface.

10. A door stop retainer assembly according to claim 1, wherein said catch member includes a threaded fastener for attaching said catch member to the other of the door and the surface.

11. A door stop retainer assembly according to claim 1, wherein said catch member comprises a plurality of slits in said substantially solid surface.

12. A door stop retainer comprising:
a post member arranged to be secured to one of a door and a surface adjacent the door at a proximal end thereof;
a catch member secured to the other of the door and the surface adjacent the door;
said post member having an elongated body and a width of said body varying along a length thereof between said proximal end, an intermediate portion and a distal end, with said width being greater at an enlarged portion than at said intermediate portion, said enlarged portion being positioned at said distal end;
said catch member having a substantially solid surface with at least one slit formed therein for receiving said distal end of said post member.

13. A door stop retainer assembly according to claim 12, wherein said catch member comprises a hollow hemispherical shape.

14. A door stop retainer assembly according to claim 12, wherein said catch member includes an adhesive layer for attaching said catch member to one of said door and said surface.

15. A door stop retainer assembly according to claim 12, wherein said catch member includes a threaded fastener for attaching said catch member to the other of the door and the surface.

16. A door stop retainer assembly according to claim 12, wherein said catch member comprises a plurality of slits in said substantially solid surface.

17. A door stop retainer assembly comprising:
a post member having a body arranged to be secured to one of a door and a surface adjacent the door at a proximal end thereof and extending away from the one of the door and the surface to a distal end, with said distal end having a width greater than a width at an intermediate portion;
a catch member, arranged to be secured to the other of the door and the surface adjacent the door, comprising a hollow hemispherical shape formed by a substantially solid wall made of an elastic and resilient material, at least one slit formed in said wall for receiving said distal end of said post member and an attachment member to secure said catch member to the other of the door and the surface.

18. A door stop retainer assembly according to claim 17, wherein said catch member comprises a plurality of slits in said substantially solid surface.

19. A door stop retainer assembly according to claim 17, wherein said attachment member comprises an adhesive layer.

20. A door stop retainer assembly according to claim 17, wherein said attachment member comprises a threaded fastener.
